(19) United States
(12) Patent Application Publication
(10) Pub. No.: US 2026/0133531 A1
(43) Pub. Date: May 14, 2026

(54) STIFFNESS MEASUREMENT APPARATUS AND IMAGE FORMING SYSTEM

(71) Applicant: Konica Minolta, Inc., Tokyo (JP)

(72) Inventor: Tomomi IZAWA, Tokorozawa-shi (JP)

(21) Appl. No.: 19/384,273

(22) Filed: Nov. 10, 2025

(30) Foreign Application Priority Data
Nov. 13, 2024 (JP) 2024-198258

(51) Int. Cl. G03G 15/00

(52) U.S. Cl. CPC G03G 15/6558; G03G 15/5029; G03G 2215/00738

(57) ABSTRACT

A stiffness measurement apparatus includes a presser that presses a sheet material, a reaction force measurer that is attached to the presser and measures a reaction force that the presser receives when the presser presses the sheet material, and a hardware processor that obtains a stiffness of the sheet material based on the reaction force measured by the reaction force measurer. The presser has a notch at a position corresponding to the reaction force measurer.

### CROSS REFERENCE TO RELATED APPLICATIONS

The present invention claims priority under 35 U.S.C. § 119 to Japanese Patent Application No. 2024-198258 filed on Nov. 13, 2024, is incorporated herein by reference in its entirety.

### BACKGROUND OF THE INVENTION

### Technical Field

The present disclosure relates to a stiffness measurement apparatus that measures stiffness of a sheet, and an image forming system including the same.

### Description of Related Art

For an image forming system that forms an image on a sheet (sheet material), a technique of detecting stiffness of the sheet and setting various control parameters is known.

For example, the technique described in Japanese Unexamined Patent Publication No. 2023-30480 measures the stiffness of the sheet by holding the sheet in a stopped state, pressing an end of the sheet, and measuring the reaction force.

### SUMMARY OF THE INVENTION

A blade that presses a sheet at the time of stiffness measurement is integrally formed with a load cell that measures a reaction force. The load cell needs to be attached to the blade so that a strain gauge part that detects strain does not come into contact with the blade.

However, when a spacer is simply interposed between the blade and the load cell for the purpose of separating the strain gauge part and the blade (see FIG. 9), an increase in the number of components and complication of assembly are caused. In addition, the interposition of the spacer may deteriorate the holding accuracy of the blade, and, by extension, deteriorate the pressing accuracy. Furthermore, since the size of the pressing unit is increased by the size of the spacer, it is necessary to secure a wider operating range thereof. As a result, the arrangement of surrounding constituent components is restricted, and the degree of freedom in component layout decreases.

The present disclosure has been made in view of the above circumstances, and an object of the present disclosure is to suitably measure the reaction force with a simple configuration.

To achieve at least one of the abovementioned objects, according to an aspect of the present invention, a stiffness measurement apparatus reflecting one aspect of the present invention includes:
a presser that presses a sheet material;
a reaction force measurer that is attached to the presser and measures a reaction force that the presser receives when the presser presses the sheet material; and
a hardware processor that obtains a stiffness of the sheet material based on the reaction force measured by the reaction force measurer,
wherein the presser has a notch at a position corresponding to the reaction force measurer.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating an image forming system according to an embodiment;

FIG. 2 is a side view of a stiffness measurement apparatus according to the embodiment;

FIG. 3 is a plan view of the stiffness measurement apparatus according to the embodiment;

FIG. 4 is a block diagram which shows a schematic control configuration of the stiffness measurement apparatus according to the embodiment;

FIG. 5 is a flowchart illustrating a flow of operation of the stiffness measurement apparatus according to the embodiment;

FIG. 6 is a schematic diagram for explaining the operation of the stiffness measurement apparatus according to the embodiment;

FIG. 7 is a schematic diagram for explaining the operation of the stiffness measurement apparatus according to the embodiment;

FIG. 8 is a partial plan view of the stiffness measurement apparatus according to the embodiment; and

FIG. 9 is a diagram illustrating a configuration in which a spacer is disposed between a blade and a load cell.

### DETAILED DESCRIPTION

Hereinafter, one or more embodiments of the present invention will be described with reference to the drawings. However, the scope of the invention is not limited to the disclosed embodiments.

Hereinafter, an embodiment of the present disclosure will be described with reference to the drawings.

### [Configuration of Image Forming System]

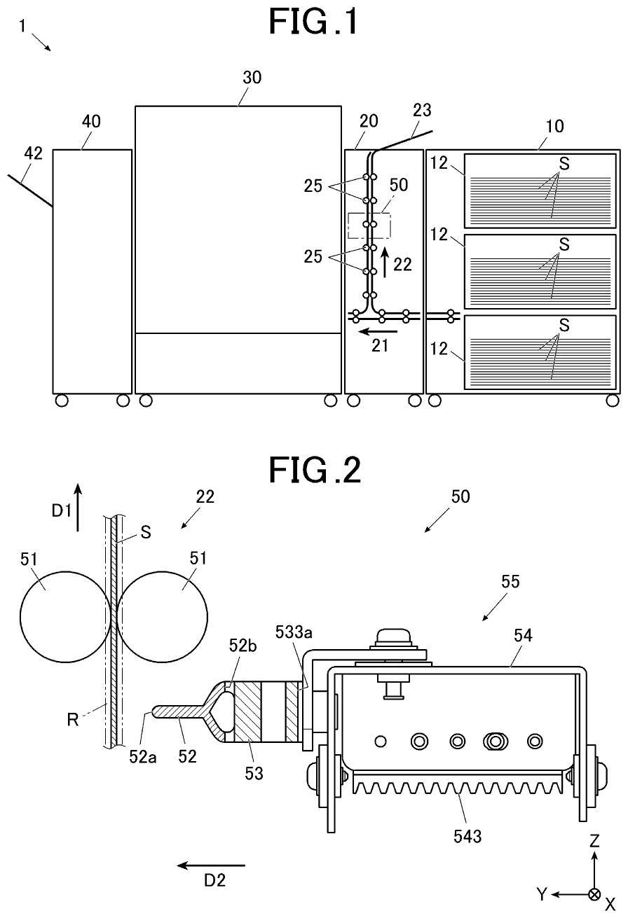

FIG. 1 is a view illustrating an image forming system 1 according to the present embodiment.

As illustrated in this figure, the image forming system 1 includes a sheet feed device 10, a sheet conveyance device 20, an image forming apparatus 30, and a post-processing device 40.

The sheet feed device 10 includes a plurality of sheet feed trays 12 on which various types of sheets S classified by basis weight, size, and the like are placed. The sheet feed device 10 supplies predetermined sheets S one by one to the sheet conveyance device 20 based on a print job from a controller (not shown).

Each sheet S is a recording medium on which an image is formed, and is an example of a sheet material according to the present disclosure. The material or the like of the sheet S is not particularly limited as long as the sheet S is a sheet material whose stiffness can be measured.

The sheet conveyance device 20 is disposed on the downstream side of the sheet feed device 10 in the conveyance direction and on the upstream side of the image forming apparatus 30 in the conveyance direction. The sheet conveyance device 20 includes a first conveyance path 21 to convey the sheet S conveyed from the sheet feed device 10 to the image forming apparatus 30, and a second conveyance path 22 branched from the first conveyance path 21. The second conveyance path 22 causes the sheet S to be branched from the first conveyance path 21 and conveys the sheet S to a second discharge port 23, for example, in a case where information on the sheet S is obtained and registered.

In the second conveyance path 22, a stiffness measurement apparatus 50 is provided which obtains the stiffness of the sheet S. As described later, the stiffness measurement apparatus 50 measures the stiffness of the sheet S whose conveyance is temporarily stopped in the middle of the second conveyance path 22. The stiffness of the sheet S is an index indicating resistance when the sheet S is bent and can be expressed by various physical quantities.

The detailed configuration and the like of the stiffness measurement apparatus 50 will be described later.

The image forming apparatus 30 forms an image using an electrophotographic process, and forms (transfers and prints) an image read from a document onto the sheet S conveyed from the sheet feed device 10. The image forming apparatus 30 receives job data including image data and setting information in a page description language (PDL) format from an external client terminal through the network and forms an image on the sheet S based on the job data.

The client terminal is, for example, a PC, a tablet, a smartphone, or the like. The image forming apparatus 30 conveys the sheet S with the image formed thereon to the post-processing device 40.

The post-processing device 40 performs predetermined post-processing on the sheet S on which an image has been formed by the image forming apparatus 30, based on a post-processing job from the controller (not shown). Examples of the post-processing include perforation processing, folding, foil stamping, binding, cutting, stapling, gluing and binding. The post-processing device 40 ejects the post-processed sheet S to a first discharge port 42.

### [Configuration of Stiffness Measurement Apparatus]

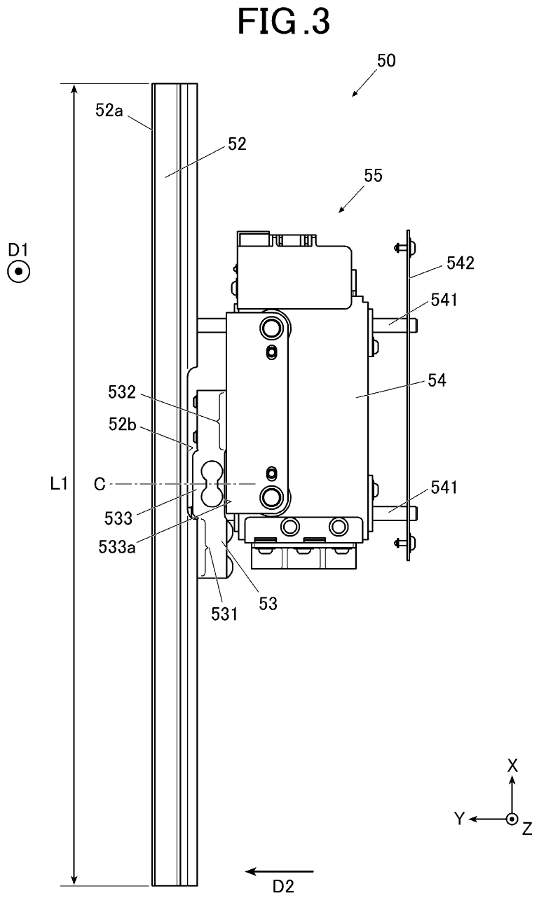

FIG. 2 and FIG. 3 are a side view and a plan view of the stiffness measurement apparatus 50, respectively.

As illustrated in FIG. 2 and FIG. 3, the stiffness measurement apparatus 50 is disposed on the second conveyance path 22 of the sheet conveyance device 20. By the second conveyance path 22, the sheet S is conveyed from the lower side to the upper side by a plurality of conveyance rollers 25 (see FIG. 1). The stiffness measurement apparatus 50 measures the stiffness of the sheet S at, of the second conveyance path 22, a portion where the conveyance direction D1 of the sheet S is upward in the vertical direction.

Hereinafter, the vertical direction along the conveyance direction D1 is referred to as a Z direction. Furthermore, a direction orthogonal to a recording surface (principal surface) of the sheet S that is conveyed in the conveyance direction D1 is referred to as a Y direction, and a width direction of the sheet S orthogonal to both the Z direction and the Y direction is referred to as an X direction.

Specifically, the stiffness measurement apparatus 50 includes a pair of holding rollers 51 and a pressing unit 55.

The pair of holding rollers 51 is a holding section (holder) that can stop and hold the sheet S being conveyed along the conveyance direction D1. Specifically, the holding rollers 51 are arranged next to each other in the Y direction, and sandwich and hold the sheet S with a predetermined holding force by, for example, being biased in a direction in which the holding rollers 51 become close to each other. The holding rollers 51 hold the sheet S in a state in which the principal surface of the sheet S is substantially orthogonal to the Y direction. In addition, the holding rollers 51 are not particularly limited, but it is preferable that the holding rollers 51 also serve as drivable conveyance rollers.

The pressing unit 55 is disposed below the holding rollers 51 and presses an end of the sheet S held by the holding rollers 51 to measure the reaction force. Specifically, the pressing unit 55 includes a blade 52, a load cell 53, and a moving mechanism 54.

The blade 52 is an example of a presser according to the present disclosure, and presses the sheet S at the time of stiffness measurement. The blade 52 is formed in a long rod shape along the X direction. An end surface of the blade 52 on one side (the left side in FIG. 2 and FIG. 3) close to a conveyance route R of the sheet S in the Y direction is a pressing surface 52a that presses the sheet S. The length L1 of the pressing surface 52a in the X direction is longer than the maximum width of the sheet S. The blade 52 presses the sheet S with the pressing surface 52a along a pressing direction D2 that is orthogonal to the conveyance direction D1 and directed from the other side to the one side in the Y direction.

In addition, the blade 52 has a concave notch 52b in the surface on the other side in the Y direction which is positioned on the side opposite to the pressing surface 52a in the Y direction.

The notch 52b is formed at a position in the X direction corresponding to the load cell 53. Specifically, the notch 52b is disposed in the vicinity of an attachment part of the blade 52 and the load cell 53. More specifically, the notch 52b is formed at a position corresponding to a portion of the load cell 53 excluding a first attachment part 531, which will be described later, in the X direction. In other words, the notch 52b is not formed in a portion of the load cell 53 corresponding to the first attachment part 531, which will be described later, but is formed in portions of the load cell 53 corresponding to a second attachment part 532 and a strain gauge part 533, which will be described later. The notch 52b makes it possible to prevent contact between the blade 52 and the load cell 53 (strain gauge part 533).

Note that the notch 52b is formed at least at a position corresponding to the strain gauge part 533 of the load cell 53. Furthermore, it is sufficient that the notch 52b is formed at a position corresponding to the load cell 53.

The load cell 53 is an example of a reaction force measurer according to the present disclosure, and measures a reaction force that the blade 52 receives when the blade 52 presses the sheet S. The load cell 53 is a beam type formed in a rectangular columnar shape elongated in the X direction and is arranged on the other side in the Y direction relative to the blade 52. That is, the load cell 53 is arranged on the opposite side in the Y direction via the blade 52 with respect to the sheet S pressed by the blade 52. The load cell 53 is disposed at the center of the blade 52 in the X direction. More specifically, center positions C of the blade 52 and the load cell 53 in the X direction substantially coincide with each other. Further, the center in the width direction of the sheet S conveyed and held by the holding rollers 51 also substantially coincides with the center position(s) C.

The load cell 53 includes a first attachment part 531 and a second attachment part 532 disposed next to each other in the X direction.

The first attachment part 531 is provided on one end side (lower side in FIG. 3) of the load cell 53 in the X direction and is attached to the blade 52. More specifically, the load cell 53 is fixed to the blade 52 by, for example, screws or adhesion in a state where a surface of the first attachment part 531 on one side in the Y direction is in contact with a surface of the blade 52 on the other side in the Y direction. The first attachment part 531 is located at a position of the blade 52 in the X direction where no notch 52b is present, and the blade 52 and the load cell 53 are in contact with each other only at the first attachment part 531.

The second attachment part 532 is provided on the other end side (upper side in FIG. 3) of the load cell 53 in the X direction and is attached to the moving mechanism 54. More specifically, the load cell 53 is fixed to the moving mechanism 54 by, for example, screws or adhesion in a state where a surface of the second attachment part 532 on the other side in the Y direction is in contact with a surface of the moving mechanism 54 on one side in the Y direction. The second attachment part 532 is located at a position of the blade 52 corresponding to the notch 52b in the X direction.

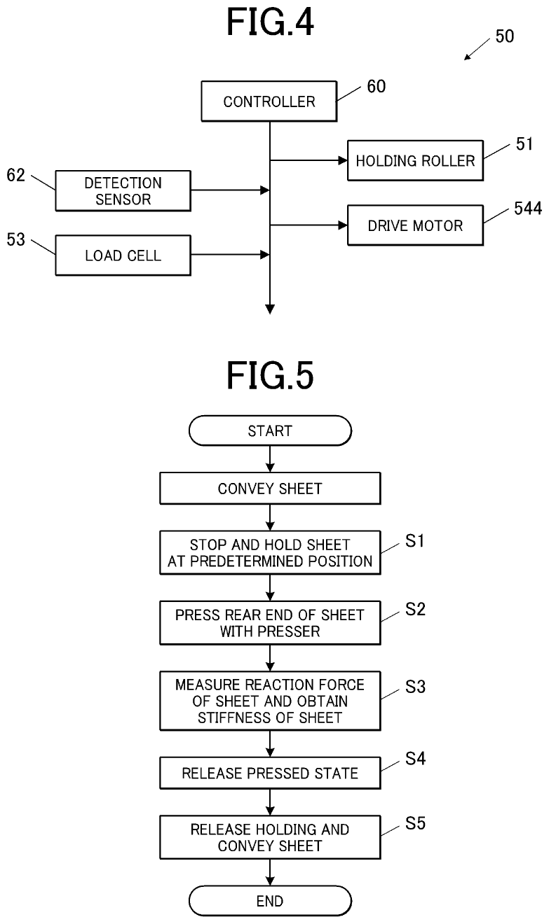

A central part of the load cell 53 in the X direction located between the first attachment part 531 and the second attachment part 532 is the strain gauge part 533. The strain gauge part 533 is in contact with neither the blade 52 nor the moving mechanism 54. The strain gauge part 533 of the present embodiment, although not particularly limited, has a surface on one side in the Y direction slightly protruding as compared with the first attachment part 531 and the second attachment part 532. The strain gauge part 533 includes a strain gauge (not illustrated) bonded to a side surface in the Y-direction. The strain gauge detects strain generated in the strain gauge part 533 and outputs the detected strain to a controller 60 (hardware processor) (see FIG. 4).

In addition, a second notch 533a that is concave is formed in a surface of the strain gauge part 533 on the other side in the Y direction. The second notch 533a is formed at a portion corresponding to the moving mechanism 54, and a part of one end side in the X direction reaches the first attachment part 531. The second notch 533a reduces the risk of contact between the strain gauge part 533 and the moving mechanism 54.

The moving mechanism 54 moves the blade 52 in the Y direction perpendicular to the sheet S. The moving mechanism 54 is formed in the shape of a rectangular box and is attached to the second attachment part 532 of the load cell 53. The moving mechanism 54 of the present embodiment is supported so as to be movable on guide rails 541 extending in the Y direction. The other side of the guide rails 541 in the Y direction is fixed to a case plate 542. A rack gear 543 extending in the Y direction is provided on a lower surface of the moving mechanism 54. The rack gear 543 meshes with a drive motor 544 (see FIG. 4) such as a stepping motor. With this configuration, the moving mechanism 54 moves in the Y direction together with the blade 52 fixed via the load cell 53 in accordance with driving of the drive motor 544.

Note that the configuration of the moving mechanism 54 is not particularly limited as long as the moving mechanism 54 can move the blade 52 in the Y direction.

FIG. 4 is a block diagram illustrating a schematic control configuration of the stiffness measurement apparatus 50.

As illustrated in this figure, the stiffness measurement apparatus 50 includes a detection sensor 62 and the controller 60.

The detection sensor 62 is disposed, for example, beside the conveyance route R of the sheet S on the upstream side of the holding rollers 51 in the conveyance direction D1 and detects the position of the sheet S in the conveyance direction D1. The detection sensor 62 of the present embodiment is a sensor capable of detecting the passing of the sheet S in the conveyance direction D1, that is, the lower end of the sheet S, and outputs the detection result to the controller 60.

The controller 60 is configured by including, for example, a central processing unit (CPU), a random access memory (RAM), a read only memory (ROM), and the like, and controls the operation of each component of the stiffness measurement apparatus 50.

Specifically, the controller 60 controls the operation of the holding rollers 51 and the drive motor 544 of the moving mechanism 54 based on the output from the detection sensor 62 or the like and obtains the stiffness of the sheet S based on the output from the strain gauge of the load cell 53. Note that the controller 60 may not control only the stiffness measurement apparatus 50, but may control, for example, the entire image forming system 1.

[Operation of Stiffness Measurement Apparatus]

Operation of the stiffness measurement apparatus 50 at the time of stiffness measurement will be described.

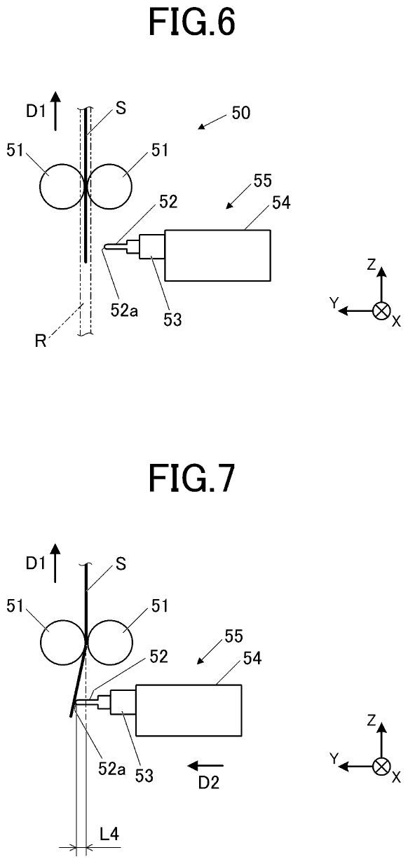

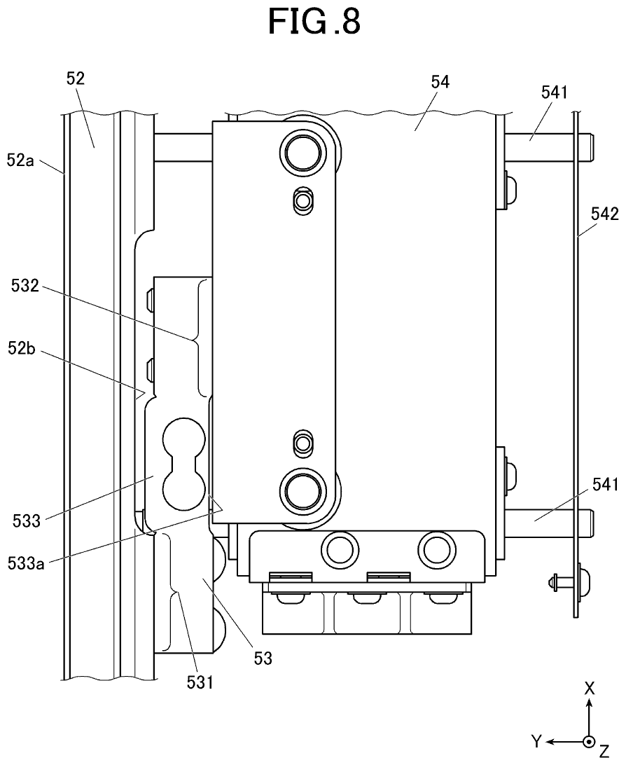

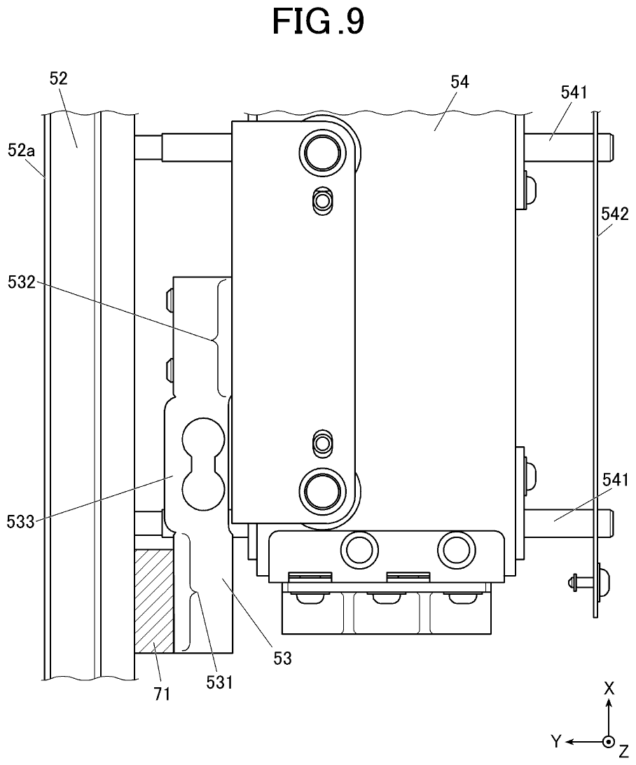

FIG. 5 is a flowchart illustrating a flow of the operation of the stiffness measurement apparatus 50 during stiffness measurement. FIG. 6 and FIG. 7 are schematic diagrams for explaining the operation of the stiffness measurement apparatus 50. FIG. 8 is a partial plan view of the stiffness measurement apparatus 50, and FIG. 9 is a diagram illustrating the configuration in which a spacer is disposed between the blade 52 and the load cell 53.

Here, for example, it is assumed that the stiffness measurement on the sheet S being conveyed is executed based on an execution command from the controller 60. The controller 60 executes each process of or the stiffness measurement based on a program(s) stored in advance.

As shown in FIG. 5, at the time of the stiffness measurement, first, the controller 60 stops and holds the sheet S being conveyed at a predetermined position with the holding rollers 51 based on the output of the detection sensor 62 (Step S1; FIG. 6).

Specifically, after a predetermined time from when the detection sensor 62 detects the passing of the rear end of the sheet S, the controller 60 stops the conveyance of the sheet S and holds the sheet S with the holding rollers 51. Thus, the rear end (lower end) of the sheet S in the conveyance direction D1 is held at a predetermined stiffness measurement position that is, for example, a position at a predetermined distance from a nip portion of the holding rollers 51 in the up-down direction.

Next, the controller 60 drives the drive motor 544 of the moving mechanism 54 to move the blade 52 in the pressing direction D2, thereby pressing the rear end of the sheet S (Step S2; FIG. 7). Accordingly, the rear end of the sheet S is pressed and bent toward one side in the Y direction with the nip portion of the holding rollers 51 as a base end.

Specifically, the controller 60 detects, for example, based on the output of the load cell 53, the position where the tip end of the blade 52 starts to contact with the principal surface of the sheet S, and sets this position as a reference position of the blade 52. The controller 60 moves the blade 52 toward the one side in the Y direction by a predetermined distance L4 (e.g., several millimeters) from the reference position. Thus, the blade 52 pushes/presses, bends, and warps the rear end of the sheet S.

Next, the controller 60 measures a reaction force that the blade 52 receives from the sheet S and obtains the stiffness of the sheet S based on the measured reaction force (Step S3).

Specifically, the controller 60 obtains from the load cell 53, the reaction force that the blade 52 receives from the sheet S, and obtains, for example, this reaction force (pressing force) as the stiffness of the sheet S.

In the stiffness measurement apparatus 50 of the present embodiment, as shown in FIG. 8, the blade 52 has the notch 52b at a position corresponding to the load cell 53. Thus, contact between the blade 52 and the load cell 53 can be suitably avoided.

On the other hand, for example, as illustrated in FIG. 9, in a case where a spacer 71 is disposed between the blade 52 and the load cell 53 to avoid the contact between the blade 52 and the strain gauge part 533, the pressing unit 55 becomes large on the other side in the Y direction. In this case, an increase in the number of components and complication of assembly are caused by the spacer 71. In addition, the interposition of the spacer 71 may deteriorate the holding accuracy of the blade 52, and, by extension, deteriorate the pressing accuracy. Furthermore, since the size of the pressing unit 55 is increased by the size of the spacer 71, it is necessary to secure a wider operation range. As a result, the arrangement of surrounding constituent components is restricted, and the degree of freedom in component layout decreases.

According to the stiffness measurement apparatus 50 of the present embodiment, it is possible to suitably measure the reaction force with a simple configuration without causing such disadvantages.

Next, as illustrated in FIG. 5, the controller 60 releases the pressed state of the sheet S by the blade 52 (Step S4).

Here, the controller 60 drives the drive motor 544 of the moving mechanism 54 to move the blade 52 in the Y direction and return the blade 52 to the normal position (position in FIG. 2) on the other side in the Y direction relative to the conveyance route R. Thus, the pressed state of the sheet S by the blade 52 is released.

Next, the controller 60 releases the holding of the sheet S by the holding rollers 51, conveys the sheet S with the conveyance rollers 25, and discharges the sheet S from the second discharge port 23 (Step S5).

Thus, the measurement of the stiffness of the sheet S ends. The obtained stiffness of the sheet S is used for setting of control parameters related to image formation. The setting of the control parameters may be executed in the same manner as the determination of the image formation condition described in, for example, Japanese Unexamined Patent Publication No. 2023-030480.

### Technical Effects of Present Embodiment

As described above, according to the present embodiment, the blade 52 (presser) has the notch 52b at the position corresponding to the load cell 53 (reaction force measurer).

Thus, contact between the blade 52 and the load cell 53 can be avoided. That is, unlike the case where a spacer is interposed between the blade 52 and the load cell 53, it is possible to suitably avoid contact between the blade 52 and the load cell 53 without increasing the number of components or complicating assembly. Furthermore, deterioration in pressing accuracy due to deterioration in holding accuracy of the blade 52 and a decrease in the degree of freedom of component layout due to an increase in the size of the pressing unit 55 do not occur.

Therefore, the reaction force can be suitably measured with a simple configuration.

Further, according to the present embodiment, the notch 52b of the blade 52 is formed at a position corresponding to at least the strain gauge part 533 of the load cell 53.

Thus, contact between the blade 52 and the strain gauge part 533 can be avoided more reliably.

Further, according to the present embodiment, the blade 52 is in contact with the load cell 53 only at the first attachment part 531.

Thus, it is possible to avoid contact between the blade 52 and the strain gauge part 533 and to suitably transmit the reaction force that the blade 52 receives to the load cell 53.

Further, according to the present embodiment, of the load cell 53, the second attachment part 532 that is attached to the moving mechanism 54 (another member) is disposed at a position corresponding to the notch 52b of the blade 52.

Thus, contact between the blade 52 and the second attachment part 532 can also be avoided.

Further, according to the present embodiment, the blade 52 is formed to be elongated along the width direction (X direction) of the sheet S, and the load cell 53 is arranged at the center of the blade 52 in the longitudinal direction.

Thus, the reaction force that the blade 52 widely receives in the X direction can be suitably measured by the load cell 53.

Further, according to the present embodiment, the conveyance direction D1 of the sheet S is the vertical direction, and the blade 52 presses the sheet material in the direction orthogonal to the conveyance direction D1.

Thus, the influence of gravity can be minimized when the sheet S is pressed. Consequently, the stiffness measurement can be accurately performed.

Further, according to the present embodiment, of the blade 52, the pressing surface 52a that presses the sheet S is longer than the maximum width of the sheet S.

Thus, the sheet S can be suitably pressed over the entire width. Consequently, the stiffness of the sheet S can be suitably measured.

Further, according to the present embodiment, the load cell 53 is disposed on the opposite side of the blade 52 with respect to the sheet S pressed by the blade 52.

Thus, the reaction force acting on the blade 52 from the sheet S can be suitably measured by the load cell 53.

Further, according to the present embodiment, the blade 52 presses an end of the sheet S.

Thus, it is possible to warp only the end of the sheet S and suitably generate a reaction force. Consequently, the stiffness can be suitably measured.

Further, according to the present embodiment, the holding rollers 51 stop and hold the sheet S being conveyed, and the blade 52 presses the sheet S held by the holding rollers 51.

Thus, the sheet S being conveyed can be held and the stiffness thereof can be suitably measured.

### Others

Although one embodiment of the present disclosure has been described above, embodiments to which the present disclosure can be applied are not limited to the above-described embodiment and modification examples thereof, and the present disclosure can be appropriately modified without departing from the scope of the present disclosure.

For example, although the conveyance direction D1 of the sheet S is along the vertical direction in the embodiment described above, the conveyance direction according to the present disclosure may not be along the vertical direction.

Furthermore, in the above embodiment, the stiffness measurement apparatus 50 is provided in the sheet conveyance device 20. However, the position of the stiffness measurement apparatus in the image forming system is not particularly limited, and for example, the stiffness measurement apparatus may be disposed in the image forming apparatus.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. A stiffness measurement apparatus comprising:
a presser that presses a sheet material;
a reaction force measurer that is attached to the presser and measures a reaction force that the presser receives when the presser presses the sheet material; and
a hardware processor that obtains a stiffness of the sheet material based on the reaction force measured by the reaction force measurer,
wherein the presser has a notch at a position corresponding to the reaction force measurer.

2. The stiffness measurement apparatus according to claim 1,
wherein the reaction force measurer includes a strain gauge part that detects a strain, and
wherein the notch is formed at least at a position corresponding to the strain gauge part.

3. The stiffness measurement apparatus according to claim 1,
wherein the reaction force measurer includes a first attachment part that is attached to the presser, and
wherein the presser is in contact with the reaction force measurer only at the first attachment part.

4. The stiffness measurement apparatus according to claim 1,
wherein the reaction force measurer includes a first attachment part that is attached to the presser and a second attachment part that is attached to another member,
wherein the first attachment part and the second attachment part are disposed next to one another along a longitudinal direction of the presser,
wherein the first attachment part is attached to, of the presser, a portion where the notch is not present, and
wherein the second attachment part is disposed at a position corresponding to the notch of the presser.

5. The stiffness measurement apparatus according to claim 1,
wherein the presser is formed to be elongated along a width direction of the sheet material that is pressed by the presser, and
wherein the reaction force measurer is disposed at a center of the presser in a longitudinal direction.

6. The stiffness measurement apparatus according to claim 1,
wherein a conveyance direction of the sheet material is a vertical direction, and
wherein the presser presses the sheet material in a direction orthogonal to the conveyance direction.

7. The stiffness measurement apparatus according to claim 1, wherein, of the presser, a portion that presses the sheet material is longer than a maximum width of the sheet material.

8. The stiffness measurement apparatus according to claim 1, wherein the reaction force measurer is disposed on a side opposite to, via the presser, the sheet material that is pressed by the presser.

9. The stiffness measurement apparatus according to claim 1, comprising a moving mechanism that moves the presser,
wherein the moving mechanism moves the presser perpendicularly to the sheet material.

10. The stiffness measurement apparatus according to claim 9, wherein the reaction force measurer includes a second attachment part that is attached to the moving mechanism.

11. The stiffness measurement apparatus according to claim 1, wherein the presser presses an end of the sheet material.

12. The stiffness measurement apparatus according to claim 1, comprising a holder capable of stopping and holding the sheet material being conveyed,
wherein the presser presses the sheet material held by the holder.

13. An image forming system comprising:
an image forming apparatus;
a sheet feed device that feeds the sheet material to the image forming apparatus; and
the stiffness measurement apparatus according to claim 1,
wherein the stiffness measurement apparatus is disposed on a conveyance route of the sheet material provided between the sheet feed device and the image forming apparatus.
